(19) United States
(12) Patent Application Publication
(10) Pub. No.: US 2009/0152479 A1
(43) Pub. Date: Jun. 18, 2009

(54) CAMERA-BASED FLAME DETECTOR

(75) Inventor: Hubert BRAENDLE, Oberengstringen (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 12/389,397

(22) Filed: Feb. 20, 2009

Related U.S. Application Data
(63) Continuation of application No. PCT/CH2006/000463, filed on Aug. 25, 2006.

(51) Int. Cl. G01J 1/42; G01J 3/51

(52) U.S. Cl. 250/554; 250/226

(57) ABSTRACT

A simple, multi-spectral flame detector is disclosed. Such a flame detector has an optical imaging system that is adapted to project several images of the flame onto the same camera. The images are from differing spectral regions. The imaging system comprises several lens devices arranged side by side, e.g., the imaging optics comprise several lens devices arranged side by side, such that each lens device is receiving part of the light from the flame. Each lens device projects one image onto one region of the camera. In this configuration, no beam splitters or mirrors are required, such components being expensive and difficult to align.

### RELATED APPLICATION

This application claims priority as a continuation application under 35 U.S.C. §120 to PCT/CH2006/000463 filed as an International Application on Aug. 25, 2006 designating the U.S., the entire content of which is hereby incorporated by reference in its entirety.

### TECHNICAL FIELD

The disclosure relates to flame detectors using a camera for recording a spatially resolved image of the flame.

### BACKGROUND INFORMATION

Flame detectors (flame scanners) are considered to be one of the most critical devices within the combustion chamber of commercial heating equipment, such as steam boilers, water heaters, or gas, oil or coal fired furnaces. The flame detector is a safety device, which detects if the pilot light or main flame is actually lit. When properly installed and serviced, it is designed to prevent boiler explosions caused by the ignition of fuel accumulated within the burner chamber during a flame failure. Flame failure is defined as a boiler condition when the flame within the boiler combustion chamber has been unintentionally discontinued due to faulty equipment or operation.

DE 197 10 206 describes a flame detector having imaging optics that project the light from the flame onto several cameras, with differing spectral filters arranged in front of the cameras.

WO 02/070953 describes a flame detector having imaging optics that project several images of the flame onto different spatial regions of a single camera, wherein the images have different spectral composition. The imaging optics consist of an assembly of several beam splitters and mirrors.

### SUMMARY

The problem to be solved by the present disclosure is to provide a simple flame detector. For example, imaging optics comprise several lens devices arranged side by side, such that each lens device is receiving part of the light from the flame. Each lens device projects one image onto one region of the camera. In this configuration, no beam splitters or mirrors are required, which is advantageous because such components are expensive and difficult to align.

A flame detector for monitoring a flame is disclosed comprising: a camera, an optical imaging system for projecting several images of said flame in different spectral regions onto different spatial regions of the camera, at least one color filter, wherein said optical imaging system comprises several lens devices arranged side by side, each lens device projecting one of said images onto one of said regions of the camera.

### BRIEF DESCRIPTION OF THE DRAWINGS

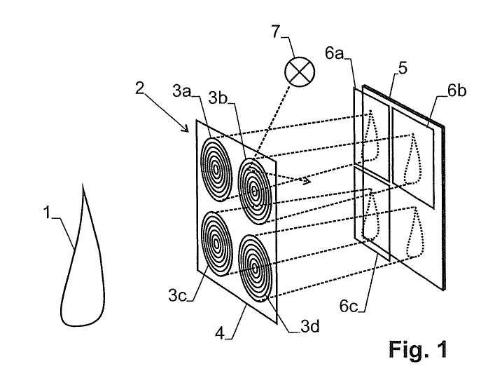

Further exemplary embodiments, advantages and applications of the disclosure are disclosed in the following description, which makes reference to FIG. 1, which shows an exemplary embodiment of the disclosure.

### DETAILED DESCRIPTION

By projecting all images onto the same camera, all of them are recorded by a single device, which obviates problems caused by the variance of sensitivity between different camera devices that may affect the reliability of the system of DE 197 10 206. In addition, only a single camera is required, which reduces the costs for manufacturing the flame detector.

The lens devices can be arranged on a common carrier, which simplifies their adjustment. For example, the common carrier can carry several Fresnel lenses arranged side by side.

FIG. 1 shows an exemplary embodiment of a flame detector for monitoring a flame 1. The flame detector comprises an optical imaging system 2, which, in the present exemplary embodiment, comprises several lens devices on a common carrier 4. Each lens device 3a, 3b, 3c, 3d can be a Fresnel lens formed on the transparent carrier 4.

The lens devices 3a, 3b, 3c, 3d are arranged side by side in a common plane defined by carrier 4, which plane is arranges substantially tangentially to a sphere with its center in flame 1, such that each lens device directly receives part of the light emitted by flame 1.

Each lens device 3a, 3b, 3c, 3d projects one image of flame 1 onto camera 5. Camera 5 is single chip CCD camera, e.g. having a silicon substrate. The concurrent projection of the four images onto camera 5 is, in the present exemplary embodiment, such that each image is projected into one quarter of the camera and all images have the same size.

The four lens devices 3a, 3b, 3c, 3d are arranged substantially symmetrically about an axis joining flame 1 and camera 5 such that each lens device receives substantially the same amount of light.

Color filters 6a, 6b, 6c are arranged between three of the lens devices, namely lens devices 3a, 3b, 3c, and the corresponding images on camera 5, each lens device filtering the light for one of the images. The color filters can e.g. be applied directly to camera 5 or they can be placed at a distance thereof. In particular, the filters can also be mounted to carrier 4. The color filters can also be located in front of the lens devices, but an arrangement closer to or immediately in front of camera 5 is advantageous because it reduces crosstalk between the different spectral channels.

The four images on camera 5 have the following spectral composition:
One image passes through a UV-band filter 6a that passes ultraviolet light but blocks visible and infrared light. UV-band filter 6a can block light of a wavelength of more than 350 nm. For example, UV-band filter 6a passes light with a wavelength between 300 and 320 nm. This is the spectral range of light from OH radicals, which is a strong indicator of an operating flame. The combustion flames of most carbon-based fuels emit sufficient ultraviolet radiation to enable a detection in this spectral range. The presence of such light is highly indicative of a live flame. However, UV-radiation can be blocked by soot or carbon particles present in the combustion chamber.
One image passes through a VIS-band filter 6b, which passes visible light and blocks ultraviolet and infrared light. VIS-band filter 6b can block light of a wavelength of less than 400 nm and of more than 780 nm while letting pass light of a wavelength between 400 and 780 nm. Light from this spectral range is typical for oil fuel combustion flames and is less prone to absorption by soot.
One image passes through an IR-band filter 6c passing infrared light and blocking visible and ultraviolet light. IR-band filter 6c can block light with a wavelength of less than 800 nm and can pass light with a wavelength of more than 800 nm. Such infrared light is indicative of most live flames, but may also be emitted by hot pieces of equipment. Its absorption in soot is less than the one of light having shorter wavelengths.
One image does not pass through any filter and therefore comprises ultraviolet, visible and infrared light from flame 1. This light is especially suited for analyzing various flame parameters such as shape, fluctuations etc. Alternatively, the full spectral width signal can be calculated from a weighted sum of the UV-, VIS-, and IR-signals instead of being measured directly.

Image processing techniques can be used for analyzing the images received by camera 5. For example:
The presence of the flame can be derived from the presence of an image having a predefined typical flame shape and typical fluctuations. Simply said, gas flames are often best detected in the ultraviolet image, oil flames in the visible range and coal flames in the infrared range.
A burning flame with non-ideal combustion can e.g. be detected from a strong flickering (strong signal variations) and/or an unusual flame shape.

In general, as can be seen from the above, the selection of the spectral range to be used in a measurement depends on the nature of the combustion. Since the present device allows measurements in different spectral ranges, it can be used for various types of combustion by simply adapting the evaluation algorithm.

The device can be provided with self-diagnostic capabilities by incorporating a light source, e.g., a light source 7 emitting UV, visible and infrared radiation. Light source 7 is positioned to send light into camera 5 to test the operation of the same. It can e.g. be switched on and off when the flame is known or assumed to be off. In that case, a signal should be generated in synchronicity with the switching on and off of light source 7. If no such signal is observed, camera 5 is probably inoperative, and a warning signal can be generated.

A light source 7 can be located such that its light falls onto the side the lens devices 3a, 3b, 3c, 3d opposite to flame 1. Part of the light reflected the lens devices 3a, 3b, 3c, 3d falls onto camera 5.

Also, it is not strictly necessary to carry out measurements in all the three mentioned spectral ranges. Depending on the desired range of applications of the flame detector, a measurement in only a subset of the said spectral ranges can be sufficient. In particular, the number of optical filters may e.g. be reduced to only two.

A plurality of the flame detectors shown here can be combined to measure the three-dimensional properties of flame 1, e.g. by positioning one flame detector along the x-axis, one detector along the y-axis and one detector along the z-axis of an orthogonal x-y-z-coordinate system with the flame being in the origin of the coordinate system.

To further improve the sensitivity of the device, an optical frequency converter can be used. In particular, a suitable UV-sensitive fluorescent material, such as a phosphor, can convert UV-light to the visible spectral range, where the sensitivity of a silicon-based camera is highest. Suitable phosphors are e.g. described in “Responsive CCD Image Sensors With Enhanced Inorganic Phosphor Coatings” by W. A. R. Franks et al., IEEE Transactions on Electron Devices, Vo. 50, No. 2, pp. 352-358. The frequency converter can e.g. be laminated to one of the filters 6a, 6b, 6c.

Similarly, frequency up-conversion can be used for converting light having a wavelength larger than 1 μm into a spectral range where a silicon-based camera is sensitive.

Suitable materials of this type are known to the person skilled in the art, and are e.g. sold by LDP LLC., 220 Broad Street, Carlstadt, N.J. 07072, USA (www.maxmax.com), e.g. under the names of IRDC2 IRUCG, IRUCR and IRUCB.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMBERS

1: flame
2: imaging system
3, 3a, 3b, 3c: lens devices
4: carrier
5: camera
6a: UV-band filter
6b: VIS-band filter
6c: IR-band filter
7: light source
8: variable filter assembly
9: filter frame
10: arrow

What is claimed is:

1. A flame detector for monitoring a flame comprising:
a camera,
an optical imaging system for projecting several images of said flame in different spectral regions onto different spatial regions of the camera,
at least one color filter,
wherein said optical imaging system comprises several lens devices arranged side by side, each lens device projecting one of said images onto one of said regions of the camera.

2. The flame detector of claim 1, wherein said at least one color filter is provided for filtering the light for one of said images, said at least one color filter being arranged between one of said lens devices and said camera.

3. The flame detector of claim 2, wherein said lens devices are arranged on a common carrier.

4. The flame detector of claim 3, wherein said carrier carries several Fresnel lenses, the several Fresnel lenses being arranged side by side.

5. The flame detector of claim 1, comprising a UV-band filter passing ultraviolet light and blocking visible and infrared light, and in particular wherein said UV-band filter blocks light of a wavelength of more than 350 nm, and in particular wherein said UV-band filter passes light with a wavelength between 300 and 320 nm.

6. The flame detector of claim 1, comprising a VIS-band filter passing visible light and blocking ultraviolet and infrared light, and in particular wherein said VIS-band filter blocks light of a wavelength of less than 400 nm and of more than 780 nm.

7. The flame detector of claim 1, comprising an IR-band filter passing infrared light and blocking visible and ultraviolet light, and in particular wherein said IR-band filter blocks light of a wavelength smaller than 800 nm.

8. The flame detector of claim 1, wherein at least one of said images comprises ultraviolet, visible and infrared light from said flame.

9. The flame detector of claim 1, further comprising a light source adapted to send light onto said camera for testing said camera, wherein said light source is located such that light therefrom is reflected from said optical imaging system to fall onto said camera.

10. The flame detector of claim 1, comprising an optical frequency converter or an optical frequency converter for converting UV-light to visible light for being projected onto said camera.

11. The flame detector of claim 1, wherein said lens devices are arranged on a common plane.

12. The flame detector of claim 1, wherein said lens devices are arranged symmetrically about an axis joining said flame and said camera.

13. The flame detector of claim 4, comprising a UV-band filter passing ultraviolet light and blocking visible and infrared light, and in particular wherein said UV-band filter blocks light of a wavelength of more than 350 nm, and in particular wherein said UV-band filter passes light with a wavelength between 300 and 320 nm.

14. The flame detector of claim 5, comprising a VIS-band filter passing visible light and blocking ultraviolet and infrared light, and in particular wherein said VIS-band filter blocks light of a wavelength of less than 400 nm and of more than 780 nm.

15. The flame detector of claim 6, comprising an IR-band filter passing infrared light and blocking visible and ultraviolet light, and in particular wherein said IR-band filter blocks light of a wavelength smaller than 800 nm.

16. The flame detector of claim 7, wherein at least one of said images comprises ultraviolet, visible and infrared light from said flame.

17. The flame detector of claim 8, further comprising a light source adapted to send light onto said camera for testing said camera, wherein said light source is located such that light therefrom is reflected from said optical imaging system to fall onto said camera.

18. The flame detector of claim 9, comprising an optical frequency converter or an optical frequency converter for converting UV-light to visible light for being projected onto said camera.

19. The flame detector of claim 10, wherein said lens devices are arranged on a common plane.

20. The flame detector of claim 11, wherein said lens devices are arranged symmetrically about an axis joining said flame and said camera.
